(19) United States
(12) Patent Application Publication
(10) Pub. No.: US 2019/0048836 A1
(43) Pub. Date: Feb. 14, 2019

(54) FUEL SUPPLY DEVICE

(71) Applicant: Kyosan Denki Co., Ltd., Koga-city, Ibraki-pref. (JP)

(72) Inventor: Masakazu SUZUKI, Koga-city (JP)

(73) Assignee: Kyosan Denki Co., Ltd., Koga-city, Ibaraki-pref. (JP)

(21) Appl. No.: 15/761,441

(22) PCT Filed: Jun. 7, 2016
(86) PCT No.: PCT/JP2016/002738

§ 371 Date: Mar. 20, 2018

(30) Foreign Application Priority Data
Sep. 24, 2015 (JP) 2015-187201

(51) Int. Cl. F02M 37/00; F02M 37/12

(52) U.S. Cl. CPC F02M 37/0017; F02M 37/0082; F02M 2200/9015; F02M 37/12; F02M 37/0047

(57) ABSTRACT

A conduit engaging mechanism has a first member and a second member. The first member and the second member define and form fuel passages extending over them. A seal member is disposed between the first member and the second member. The first member and the second member are firmly engaged in a radial direction by fittingly coupling an engaging section and a fitting section. The first member and the second member are engaged by an engaging mechanism in an axial direction. The fuel passages are communicated as a series of passages by engaging the first passage forming section and the second passage forming section. The first passage forming section has a flexible pipe. The flexible pipe suppresses extension and contraction of the seal member by deflection itself. Consequently, deterioration of the seal member is suppressed.

### CROSS REFERENCE TO RELATED APPLICATIONS

This application is based on Japanese Patent Application No. 2015-187201 filed on Sep. 24, 2015, the disclosure of which is incorporated herein by reference.

### TECHNICAL FIELD

The disclosure in this description relates to a fuel supply device which forms a fuel passage extending over two members.

### BACKGROUND

Patent Literature 1 discloses a fuel supply device. The fuel supply device has a conduit connecting mechanism which forms a fuel passage extending over two members, in order to provide a passage of a fuel. The conduit connecting mechanism has a seal member between two members. The seal member is arranged between two cylindrical surfaces in order to permit slight movement of two members in an axial direction of the fuel passage. For example, Patent Literature 1 discloses a fuel outlet 61, a fuel inlet 72, and an O-ring 68 arranged between them.

### CITATION LIST

### Patent Literature

Patent Literature 1: JP2004-28054A

### SUMMARY

In a structure of the conventional technique, a long time use may damage the seal member and deteriorate sealing nature. For example, if there is a slight movement or vibration in a radial direction of the fuel passage between two members, since the seal member repeats extensions and contractions, and then deterioration of the seal member may be promoted. In addition, like the concrete application in Patent Literature 1, when two members have a plurality of engaging sections, errors in a plurality of engaging sections may be piled up, and a positional shifting in the radial direction of the fuel passage may be created between two members. In this case, since a part of seal member changes intensively, deterioration of the seal member may be promoted.

In the above viewpoint, or in the other viewpoint not mentioned above, further improvement of a fuel supply device is still demanded.

It is an object of the present disclosure to provide a fuel supply device which can suppress deterioration of the seal member.

In order to achieve each object, a plurality of embodiments disclosed in this specification use technical measures different each other. The symbols in the parenthesis indicated in the above section and the claim merely show correspondence relations with concrete elements described in embodiments later mentioned as one example, and are not intended to limit the technical scope of this disclosure.

A fuel supply device is provided by one disclosure. The fuel supply device comprises: a passage forming section (44) which defines and forms a fuel passage (52, 62) extending over a first member (41) and a second member (42) which are engaged by an engaging mechanism (71, 271); a component engaging section (45) which engages the first member and the second member so that the first member and the second member are relatively positioned within a regular positional range; a seal member (43) which seals between the first member and the second member, and which extends and contracts according to a positional shifting of the first member and the second member within the regular positional range; and a flexible pipe (53, 453, 553) which defines and forms a part of the fuel passage, and which is possible to be deformed according to the positional shifting of the first member and the second member within the regular positional range by being arranged between the passage forming section and the component engaging section.

The first member and the second member in the fuel supply device are connected by the component engaging section. The component engaging section positions the first member and the second member relatively in the regular positional range. In the regular positional range, the first member and the second member may shift relatively. The seal member seals between the first member and the second member.

The seal member extends and contracts according to a relative shifting of the first member and the second member within the regular positional range. The flexible pipe defines and forms a part of fuel passage. In addition, the flexible pipe is arranged between the component engaging section and the passage forming section. If the first member and the second member shift within the regular positional range, the flexible pipe can be deflected. Since the flexible pipe is deflected, extension and contraction of the seal member is suppressed. As a result, deterioration of the sealing member is suppressed.

### BRIEF DESCRIPTION OF THE DRAWINGS

FIG. 1 is a block diagram of a fuel supply device according to a first embodiment;

FIG. 2 is a cross-sectional view of a conduit connecting mechanism according to the first embodiment;

FIG. 3 is a front view of the conduit connecting mechanism according to the first embodiment;

FIG. 4 is a bottom view in an arrow symbol IV in FIG. 3;

FIG. 5 is a cross sectional view of a connecting mechanism according to a second embodiment;

FIG. 6 is a cross sectional view of a connecting mechanism according to a third embodiment;

FIG. 7 is a cross sectional view of a connecting mechanism according to a fourth embodiment;

FIG. 8 is a cross sectional view of a connecting mechanism according to a fifth embodiment; and

FIG. 9 is a cross sectional view of a connecting mechanism according to a sixth embodiment.

### DETAILED DESCRIPTION

A plurality of embodiments are described referring to the drawings. In the embodiments, portions, which may be corresponded and/or associated in functionally and/or structurally, may be indicated by the same reference symbols or reference symbols which merely differs at hundred or above digits. Description of other embodiment can be referred to for corresponding portions and/or associated portions.

### First Embodiment

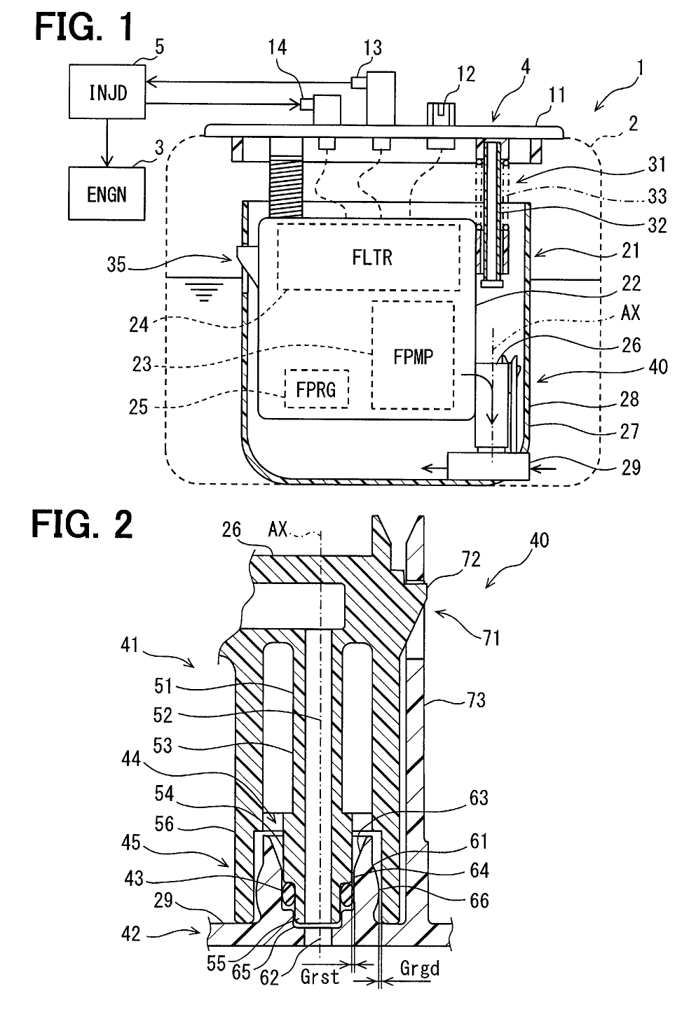

In FIG. 1, the fuel supply device 1 supplies fuel in the fuel tank 2 to an internal combustion engine (ENGN) 3. The fuel supply device 1 has a tank module 4. The tank module 4 is installed in the fuel tank 2. About the tank module 4, it is possible to refer the descriptions in JP2004-28054A1 listed as Patent Literature 1, and the descriptions are introduced by incorporation by reference as descriptions of components disclosed in this disclosure. The tank module 4 supplies the fuel in the fuel tank 2 to an injection device (INJD) 5. The injection device 5 supplies the fuel to the internal combustion engine 3. The injection device 5 may have a fuel injection valve. The injection device 5 may have a high-pressure pump which pressurizes a low pressure fuel supplied from the tank module 4.

The tank module 4 is attached on an opening of the fuel tank 2. The tank module 4 has a flange 11 which covers the opening of the fuel tank 2. The flange 11 is made of resin. The flange 11 has an electric connector 12 disposed to penetrate the flange 11. The electric connector 12 provides electric connection for electric power supply for an apparatus installed in the fuel tank 2 and/or for signal transmissions. The flange 11 has an outlet pipe 13 through which the fuel supplied to the injection device 5 from the fuel tank 2 passes. The flange 11 has a return pipe 14 through which surplus fuel returning to the fuel tank 2 from the injection device 5 passes.

The flange 11 may be formed to have at least one of the electric connector 12, the outlet pipe 13, and the return pipe 14.

For example, it is possible to employ the flange 11 without the return pipe 14. In addition, if it has no fuel pump 23 later mentioned, it is possible to employ the flange 11 without the electric connector 12.

The tank module 4 has an in-tank unit 21 arranged in the fuel tank 2. The in-tank unit 21 has a plurality of components. The in-tank unit 21 has the first component 22 and the second component 27. The first component 22 and the second component 27 are engaged with a loose fit coupling.

The first component 22 has a fuel pump (FPMP) 23 which has an electric motor. The fuel pump 23 sucks the fuel in the fuel tank 2, and supplies it to the outlet pipe 13.

The first component 22 has a filter (FLTR) 24. The filter 24 is disposed in the fuel passage between the fuel pump 23 and the outlet pipe 13. The filter 24 filters the fuel. The first component 22 has a regulator (FPRG) 25. The regulator 25 adjusts pressure of the fuel supplied by the fuel supply device 1. For example, the regulator 25 is disposed on the fuel passage between the fuel pump 23 and the outlet pipe 13, and adjusts fuel pressure in this fuel passage.

The first component 22 defines and forms the fuel passage for the fuel pump 23 and the filter 24. Since the first component 22 has the fuel pump 23, it may be also called a pump module. Since the first component 22 has the filter 24, it may be also called a filter unit. The first component 22 is also called a supporting component for supporting a functional component like the fuel pump 23. Since the first component 22 is supported by the flange 11, it may be also called a flange side part. Many parts of the first component 22 are made of resin.

The first component 22 has a connecting section 26 for supplying the fuel to a below-mentioned auxiliary pump 29. The connecting section 26 is disposed as a part of the first component 22. The connecting section 26 may be also called a first conduit belonging to the first component 22.

The second component 27 provides a subtank 28 in the fuel tank 2. The subtank 28 is a container for storing the fuel, when a fuel level in the fuel tank 2 lowers.

The second component 27 has an auxiliary pump 29. The auxiliary pump 29 pumps up the fuel from an exterior of the subtank 28 to an inside of the subtank. The auxiliary pump 29 is a fluid-power-type pump which pumps up the fuel by using the fuel flow as a power source. The auxiliary pump 29 is provided by a jet pump. The fuel of the power source for operating the auxiliary pump 29 is supplied with a discharged fuel from the regulator 25, a branched fuel from a discharge port of the fuel pump 23, a leakage fuel from a vapor exhaust passage of the fuel pump 23, and/or a returned fuel passing through the return pipe 14. In the illustrated example, the discharged fuel from the regulator 25 is supplied to the auxiliary pump 29 from the connecting section 26.

The auxiliary pump 29 may be also called an in-tank apparatus belonging to the second component 27. A fuel reserving portion of the auxiliary pump 29 may be also called a second conduit belonging to the second component 27. Since the second component 27 is installed on a bottom in the fuel tank 2, the auxiliary pump 29 may be also called a bottom disposed apparatus.

The first component 22 is supported by the flange 11. A support mechanism 31 is disposed between the flange 11 and the first component 22. The support mechanism 31 has an extension and contraction device 32. The extension and contraction device 32 is provided by a telescopic device. The extension and contraction device 32 may be provided by a guide member extending from the flange 11, and a receiving member disposed on the first component 12 and fittingly coupled with the guide member in a slidable manner. The support mechanism 31 has a spring 33 which pushes the first component 22. The spring 33 provides a bias device which pushes the first component 22 to a regular position in the fuel tank 2. The first component 22 is pushed towards the bottom of the fuel tank 2 with the spring 33.

The first component 22 and the second component 27 are engaged by the engaging mechanism 35. The engaging mechanism 35 connects the first component 22 and the second component 27 loosely. The engaging mechanism 35 provides a stable engagement which is not canceled under a usual use. On the other hand, the engaging mechanism 35 permits a slight and relative movement of the first component 22 and the second component 27.

The engaging mechanism 35 engages the upper portion of the first component 22 and the upper portion of the second component 27. The engaging mechanism 35 may be provided by a snap-fit mechanism using elasticity of resin material. The engaging mechanism 35 may be provided by a pawl disposed on the first component 22 and a hook disposed on the second component 27 to be fittingly coupled with the pawl. The engaging mechanism 35 provides engagement between the first component 22 and the second component 27 at a plurality of places. The plurality of engaging places are arranged along an outer periphery of the first component 22 in a separated manner with each other.

A conduit connecting mechanism 40 is disposed between the first component 22 and the second component 27. The conduit connecting mechanism 40 connects the connecting section 26 and the auxiliary pump 29. The conduit connecting mechanism 40 forms a fuel passage which supplies a fuel to the auxiliary pump 29 from the connecting section 26. The conduit connecting mechanism 40 is also an engaging mechanism which engages a lower part of the first component 22 and a lower part of the second component 27. The conduit connecting mechanism 40 permits slight movement of the first component 22 and the second component 27 in the axial direction along an axis AX of the fuel passage provided by itself. In addition, the conduit connecting mechanism 40 permits slight movement of the first component 22 and the second component 27 along the radial direction which intersects perpendicularly with the axis AX. In the following description, the direction along the axis AX is called an axial direction, and the direction which intersects perpendicularly with the axis AX is called a radial direction. The axial direction corresponds to a direction inserting the tank module 4 into the fuel tank 2. The axial direction corresponds to an extension and contraction direction of the support mechanism 31. The axial direction corresponds to a direction assembling the first component 22 and the second component 27 in a manufacturing method for assembling the first component 22 and the second component 27, i.e., an engaging direction for the engaging mechanism 35.

In FIG. 2, the conduit connecting mechanism 40 has a first member 41 belonging to the first component 22, and the second member 42 belonging to the second component 27. The first member 41 and the second member 42 are made of resin. The first member 41 provides the connecting section 26. The first member 41 and the second member 42 defines and forms fuel passages 52 and 62 extending over the first member 41 and the second member 42. The first member 41 and the second member 42 provide a pair of circular cylindrical seal surfaces which counter each other. A seal member 43 is disposed between the first member 41 and the second member 42. The seal member 43 is an O-ring made of rubber, or resin. The first member 41 and the second member 42 have a passage forming section 44 which defines and forms the fuel passages 52 and 62. The first member 41 and the second member 42 have a component engaging section 45 which engages the first member 41 and the second member 42 so that the first member 41 and the second member 42 may be relatively positioned within a regular positional range. The component engaging section 45 is one of a plurality of engaging sections which engage the first component 22 and the second component 27. The passage forming section 44 and the component engaging section 45 are arranged in a coaxial manner on the axis AX. The passage forming section 44 and the component engaging section 45 are separately arranged.

The main part of the first member 41 is a cylindrical first passage forming section 51 disposed on a middle portion. The first passage forming section 51 defines and forms the fuel passage 52 for passing the fuel. The first passage forming section 51 has a flexible pipe 53. The flexible pipe 53 extends along the axis AX of the fuel passage. The flexible pipe 53 defines and forms a part of fuel passage extending over the first member 41 and the second member 42. The flexible pipe 53 is arranged between the component engaging section 45 and the passage forming section 44. A one end of the flexible pipe 53 is connected to the passage forming section 44. The other end of the flexible pipe 53 is connected to a base portion of the component engaging section 45. The flexible pipe 53 may deflect according to a shifting of the first member 41 and the second member 42 within the regular positional range. The flexible pipe 53 may deflect itself so that a stress applied to the seal member 43 is suppressed.

Material and geometric configurations of the flexible pipe 53 are designed to acquire a predetermined flexibility. In the illustrated example, the thickness and the length of the wall are designed. The flexible pipe 53 is integrally formed with resin material which provides the connecting section 26. Here, the deflection includes elastic deformation. The deflection may include plastic deformation alternatively or additionally.

The first passage forming section 51 has a first insertion section 54. The first insertion section 54 is disposed on a distal end part of the first passage forming section 51. The first insertion section 54 is provided with a wall thicker than the flexible pipe 53. The first passage forming section 51 has a second insertion section 55. The second insertion section 55 is disposed on a distal end part of the first passage forming section 51. The second insertion section 55 is disposed on a further distal end side rather than the first insertion section 54. An outside diameter of the second insertion section 55 is smaller than an outside diameter of the first insertion section 54. The second insertion section 55 is provided with a wall thinner than the flexible pipe 53. The second insertion section 55 provides a circular cylindrical seal surface in contact with the seal member 43.

The first passage forming section 51, i.e., the first insertion section 54 and the second insertion section 55 provide a male engaging section in the conduit connecting mechanism 40. The first insertion section 54 and the second insertion section 55 provide an insertion section which has a rigidity higher than the flexible pipe 53.

The first member 41 has an engaging section 56. The engaging section 56 is extended towards the second component 27 from the first component 22. The engaging section 56 extends to be contact with the second component 27 directly. The engaging section 56 extends along the axial direction. The engaging section 56 may also be called an engaging leg. The engaging section 56 provides a mechanical engagement in the radial direction between the first component 22 and the second component 27. This mechanical engagement is an engagement of a rigid body and a rigid body. The engaging section 56 is a main member which defines a mechanical strength in the conduit connecting mechanism 40.

The engaging section 56 has a rigidity higher than the first passage forming section 51. The engaging section 56 has a rigidity higher than the flexible pipe 53. In particular, the rigidity of the engaging section 56 is higher than the rigidity of the flexible pipe 53 in the radial direction. The engaging section 56 is designed as a member which is not elastically deformed under a usual use condition. Therefore, although the flexible pipe 53 may be elastically deformed under almost all use condition of the fuel supply device 1, the engaging section 56 is not elastically deformed.

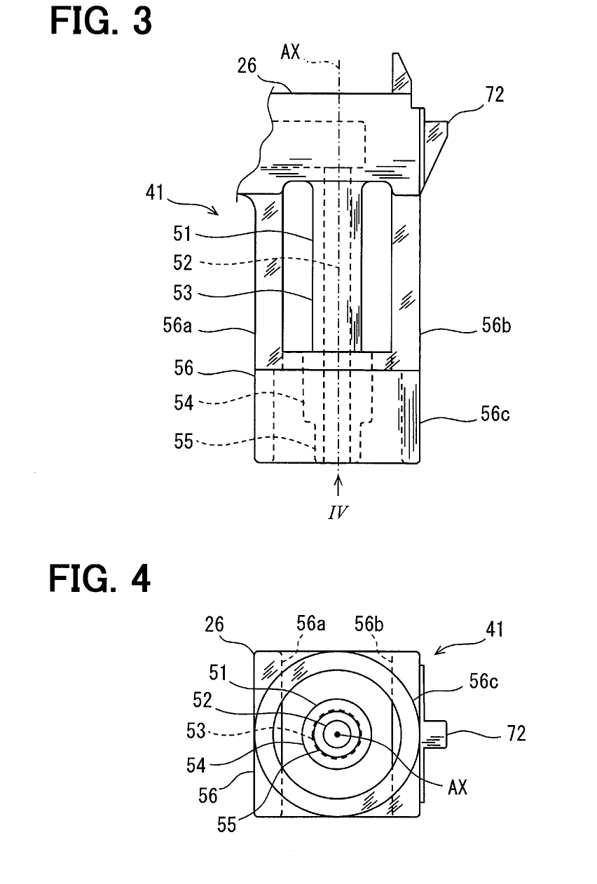

In FIGS. 3 and 4, the engaging section 56 has a pair of engaging legs 56a and 56b and an annular engaging ring 56c. A pair of engaging legs 56a and 56b extends along the axial direction from the first component 22. A pair of engaging legs 56a and 56b are members in plate shapes. A pair of engaging legs 56a and 56b are given with a sufficient thickness and also are arranged in a shape of a box so that a high rigidity is demonstrated in the radial direction. The engaging ring 56c is disposed in the distal end portion of a pair of engaging legs 56a and 56b. The engaging ring 56c contributes to give high rigidity to the engaging section 56. The engaging ring 56c is useful for secure engagement to the auxiliary pump 29. The engaging ring 56c provides firm engagement to the auxiliary pump 29 in all radial directions. The engaging ring 56c is coaxially arranged on the axis AX. The engaging legs 56a and 56b and the engaging ring 56c have shape which may be integrally molded with resin material as a part of the first component 22.

Returning to FIG. 2, the second member 42 is disposed on the auxiliary pump 29. A main part of the second member 42 is a cylindrical second passage forming section 61 disposed on a middle portion. The second passage forming section 61 defines and forms a fuel passage 62 for passing the fuel. The second passage forming section 61 is designed as a member which is not elastically deformed under a usual use condition. Therefore, although the flexible pipe 53 may be elastically deformed, the second passage forming section 61 is not elastically deformed, under almost all use conditions of the fuel supply device 1.

The second passage forming section 61 receives the first insertion section 54 and the second insertion section 55, and has a guide surface 63 for guiding towards the axis AX. The guide surface 63 is provided by an inner surface of a conical shape disposed on an open end of the second passage forming section 61.

The second passage forming section 61 has a first receiving section 64. The first receiving section 64 is disposed deeper than the guide surface 63. The first receiving section 64 provides a circular cylindrical seal surface in contact with the seal member 43. The second passage forming section 61 additionally has a second receiving section 65. The second receiving section 65 is disposed further deeper than the first receiving section 64. An inner bore diameter of the second receiving section 65 is smaller than the inner bore diameter of the first receiving section 64. The first receiving section 64 and the second receiving section 65 provide female connecting sections in the conduit connecting mechanism 40. The first receiving section 64 and the second receiving section 65 provide receiving sections which has a rigidity higher than the flexible pipe 53, and receive the insertion sections. The seal member 43 is arranged between the insertion sections and the receiving sections.

The first receiving section 64 receives the first insertion section 54. The first receiving section 64 provides an engaging section for connecting a passage by being assembled with the first insertion section 54. The second receiving section 65 receives the second insertion section 55. The second receiving section 65 provides the engaging section for connecting a passage by being assembled with the second insertion section 55.

The second member 42 has a fitting section 66. The fitting section 66 is provided by an outer peripheral surface of the second passage forming section 61. The fitting section 66 is disposed to be come in contact with the connecting section 56 directly. The fitting section 66 has a rigidity higher than the flexible pipe 53. The fitting section 66 has a shape which can be fittingly coupled with the connecting section 56. The fitting section 66 has an outside diameter which can be inserted into the engaging ring 56c. An annular clearance Grgd is formed between the engaging ring 56c and the fitting section 66. The fitting section 66 provides a mechanical engagement in the radial direction between the first component 22 and the second component 27. This mechanical engagement is an engagement of a rigid body and a rigid body. The fitting section 66 is a main member which defines a mechanical strength of the conduit connecting mechanism 40.

The fitting section 66 provides an annular curved surface which projects towards a radial outside on the outer peripheral surface of the second passage forming section 61. The annular curved surface provides the outer peripheral surface which along the axial direction from a narrow one end portion, via a thick center portion, to a narrow the other one end portion. The annular curved surface is provided by a part of a spherical object or a part of torus object. The annular curved surface provides an engagement like a ball joint between the connecting section 56 and the fitting section 66. The connecting section 56 is movable on an outside of the fitting section 66 to perform swivel like motion.

The first member 41 and the second member 42 are engaged by the engaging mechanism 71 in the axial direction. The engaging mechanism 71 is provided by a pawl 72 disposed on the first member 41 and a hook 73 disposed on the second member 42.

An outer diameter of the first insertion section 54 is smaller than an inner bore diameter of the first receiving section 64 by a predetermined amount. In a regular attachment condition, an annular clearance Grst is formed between the first insertion section 54 and the first receiving section 64. The seal member 43 is arranged between the peripheral surface of the second insertion section 55 and the inner circumference surface of the first receiving section 64, and touches both surfaces of them. The seal member 43 is arranged in a slightly pressurized manner. The clearance Grst defines an elastically deformable deformation amount of the seal member 43. Since the flexible pipe 53 is elastically deformable, the engaging section for communicating the fuel passage 52 and the fuel passage 62 between the first passage forming section 51 and the second passage forming section 61 may also be called an elastic engaging section. Since the clearance Grst is a clearance in the elastic engaging section, it may be also called an elastic clearance.

An inner bore diameter of the engaging section 56, i.e., the engaging ring 56c is smaller than the outer diameter of the fitting section 66 by a predetermined amount. In the regular attachment condition, the annular clearance Grgd is formed between the engaging ring 56c and the fitting section 66. The engaging section 56 and the fitting section 66 are able to be come into contact partly. When the engaging section 56 and the fitting section 66 touch partly, in an opposite side on a diameter, there may be formed a clearance having double width of the clearance Grgd.

The engagement provided by the engaging section 56 and the fitting section 66 is a high rigidity engagement with a clearly high rigidity compared with the engagement provided by the first passage forming section 51 and the second passage forming section 61. The engagement provided by the engaging section 56 and the fitting section 66 may also be called an engaging section by a rigid body. Since the clearance Grgd is a clearance in the engaging section by the rigid body, it may also be called a rigid-body clearance.

Positional errors between the first component 22 and the second component 27 may be created resulting from errors of component shapes in the engaging mechanism 35, and errors such as a shifting in the engaging mechanism 35. In addition, a difference may be created on the movement amount of the first component 22 and the second component 27 resulting from a fuel flow in the fuel tank 2. This difference of the movement amount may also create a positional error between the first component 22 and the second component 27. Such positional errors of the first component 22 and the second component 27 may be surfaced as a shifting in the radial direction between the first member 41 and the second member 42 in the conduit connecting mechanism 40.

If the first member 41 and the second member 42 tend to shift in the radial direction relatively, the engaging ring 56c may touch the fitting section 66 and may prevent a shifting. In this case, the first member 41 and the second member 42 may be shifted from the regular position only the clearance Grgd.

On the other hand, if the first member 41 and the second member 42 tend to shift in the radial direction relatively, the first insertion section 54 and the first receiving section 64 may shift in the radial direction relatively. At this time, since the seal member 43 is arranged between the first passage forming section 51 and the second passage forming section 61, a relative movement of the first insertion section 54 and the first receiving section 64 makes the seal member 43 extend and contract in the radial direction. The maximum amount of extension and contraction of the seal member 43 is restricted by the clearance Grst. The flexible pipe 53 deflects by a relative movement of the first insertion section 54 and the first receiving section 64. The deflection of the flexible pipe 53 reduces the relative amount of movement of the first insertion section 54 and the first receiving section 64. As a result, the amount of extension and contraction of the seal member 43 is suppressed.

The ease of deflection of the flexible pipe 53 is set to suppress an extension and contraction of the seal member 43. The ease of deflection of the flexible pipe 53 is set so that the flexible pipe 53 deflects before the first insertion section 54 and the first receiving section 64 partially contact directly when the radial force acting between the first member 41 and the second member 42 is increased gradually. Thereby, even if the first member 41 and the second member 42 move in the radial direction, extension and contraction of the seal member 43 is suppressed.

The flexible pipe 53 may be designed so that it may be deformable easier than the seal member 43. The flexible pipe 53 may be formed so that the elasticity may become lower than the elasticity of the seal member 43. In another viewpoint, the ease of deformation of the flexible pipe 53 may be designed so that a clearance may still be maintained between the first insertion section 54 and the first receiving section 64, when the engaging ring 56c and the fitting section 66 come in contact partly.

The ease of flexibility of the flexible pipe 53 may be set so that the flexible pipe 53 may be deflected by the force in the radial direction smaller than the force for extending and contracting the seal member 43 in the radial direction. The ease of flexibility of the flexible pipe 53 may be set so that the flexible pipe 53 may be deflected simultaneously by the force in the radial direction for extending and contracting the seal member 43 in the radial direction. The ease of flexibility of the flexible pipe 53 is set so that the flexible pipe 53 may be deflected by a force in the radial direction which makes an extension and contraction amount in the radial direction of the seal member 43 exceeds a predetermined value.

In the embodiment stated above, the first member 41 and the second member 42 defines and forms the fuel passages 52 and 62 extending over them. The passage forming section 44 which defines and forms the fuel passages 52 and 62 extending over the first member 41 and the second member 42 which are engaged by the engaging mechanism 71 is disposed. The passage forming section 44 is provided by the first insertion section 54, the second insertion section 55, the first receiving section 64, and the second receiving section 65. The fuel passages 52 and 62 are communicated as a series of passage by engagement of the first passage forming section 51 and the second passage forming section 61.

In addition, the component engaging section 45 which engages the first member 41 and the second member 42 so that the first member 41 and the second member 42 may be relatively positioned in the regular positional range is disposed. The regular positional range corresponds to the clearance Grgd. The flexible pipe 53 is arranged between the passage forming section 44 and the component engaging section 45. One end of the flexible pipe 53 is connected to the base portion of the component engaging section 45, i.e., the base portion of the engaging section 56. The component engaging section 45 has a rigidity higher than the flexible pipe 53. The first member 41 and the second member 42 are firmly engaged in the radial direction by fittingly coupling the engaging section 56 and the fitting section 66.

According to this embodiment, flexible deformation is permitted in the flexible pipe 53, while mechanically engaging the first member 41 and the second member 42 firmly by the engaging section 56 and the fitting section 66. The flexible pipe 53 suppresses an extension and contraction of the seal member 43 by deflection itself. Therefore, an extension and contraction of the seal member 43 in the fuel passage formed over the plurality of these members is suppressed, while positioning the plurality of members in the regular positioning relationship. Thereby, deterioration of the seal member 43 is suppressed. As a result, the conduit connecting mechanism and the fuel supply device which can maintain sealing nature over a long period of time are provided.

### Second Embodiment

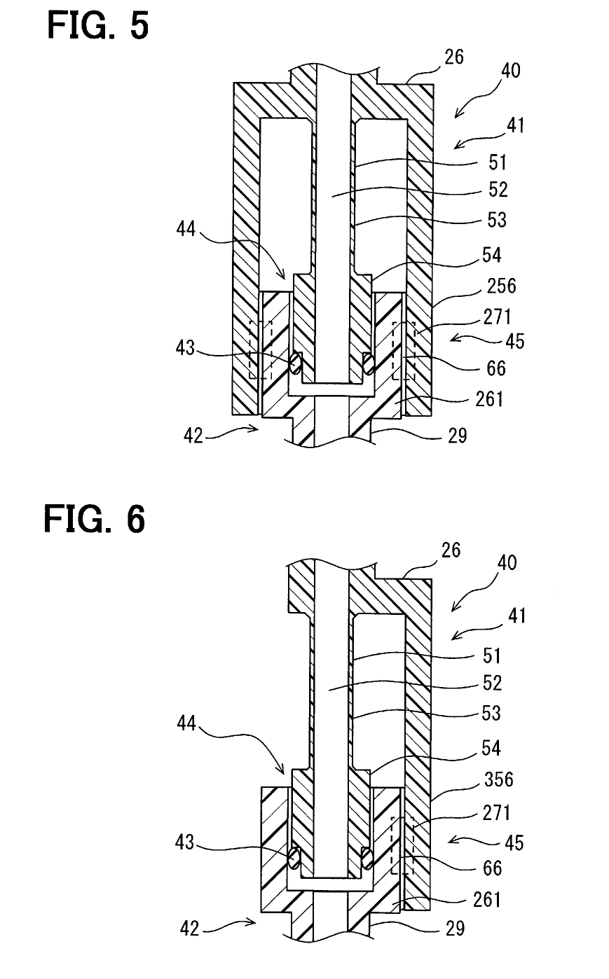

This embodiment is one of modifications based on a basic form provided by the preceding embodiment. In the preceding embodiment, the engagement in the axial direction between the first member 41 and the second member 42 is provided by the engaging mechanism 71. Alternatively, in this embodiment, as shown in FIG. 5, the engaging mechanism 271 is disposed on the component engaging section 45. The engaging mechanism 271 is disposed between the engaging section 256 and the second passage forming section 261. The engaging mechanism 271 may be provided by the snap-fit mechanism provided by the pawl and the hook. According to this embodiment, it is possible to achieve similar advantages in the preceding embodiments by a simple structure.

### Third Embodiment

This embodiment is one of modifications based on a basic form provided by the preceding embodiment. In the preceding embodiments, a pair of engaging sections 56 and 256 are disposed. Alternatively, in this embodiment, as shown in FIG. 6, engagement is provided by a single engaging section 356. According to this embodiment, it is possible to achieve similar advantages in the preceding embodiments by a simple structure.

### Fourth Embodiment

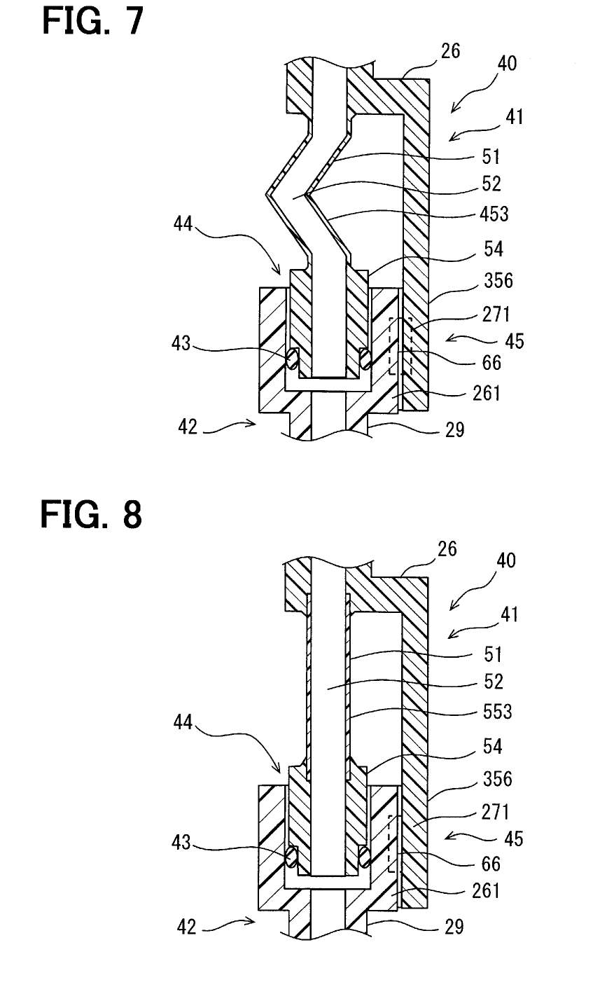

This embodiment is one of modifications based on a basic form provided by the preceding embodiment. In the preceding embodiment, the flexible pipe 53 of straight pipe is disposed. Alternatively, in this embodiment, as shown in FIG. 7, a flexible pipe 453 which winds in a zig-zag manner is disposed. Since the flexible pipe 453 is longer than the flexible pipe 53 in the preceding embodiments, it deflects easier than the flexible pipe 53 in the preceding embodiments. In addition, since the flexible pipe 453 has a part inclined to the axis AX, it deflects easier than the flexible pipe 53 in the preceding embodiments. The flexible pipe 453 may employs various configurations to obtain required ease of deflection. For example, it may employ a configuration which winds in a curved manner. In addition, a wall of the flexible pipes 53 and 453 may be formed in a bellows shape. According to this embodiment, it is possible to achieve similar advantages in the preceding embodiments.

### Fifth Embodiment

This embodiment is one of modifications based on a basic form provided by the preceding embodiment. In the preceding embodiments, the flexible pipes 53 and 453 are integrally formed with the engaging sections 56 and 356 with resin material. Alternatively, in this embodiment, as shown in FIG. 8, a flexible pipe 553 is disposed as a separate component. The flexible pipe 553 is a component separated from the engaging section 356. The flexible pipe 553 is a component separated from the first insertion section 54. The flexible pipe 553 is connected to the engaging section 356 and the first insertion section 54 by a joined portion such as insert molding and adhesion. The flexible pipe 553 is made of resin. The flexible pipe 553 may be provided by various materials, such as metal.

The flexible pipe 553 may be integrally formed with the engaging section 356 or the first insertion section 54 with resin material. The flexible pipe 553 may be provided as a component separated from the passage forming section 44 and/or the component engaging section 45. The flexible pipe 553 may be integrally formed with the passage forming section 44 and/or the component engaging section 45 with resin material.

According to this embodiment, it is possible to achieve similar advantages in the preceding embodiments.

### Sixth Embodiment

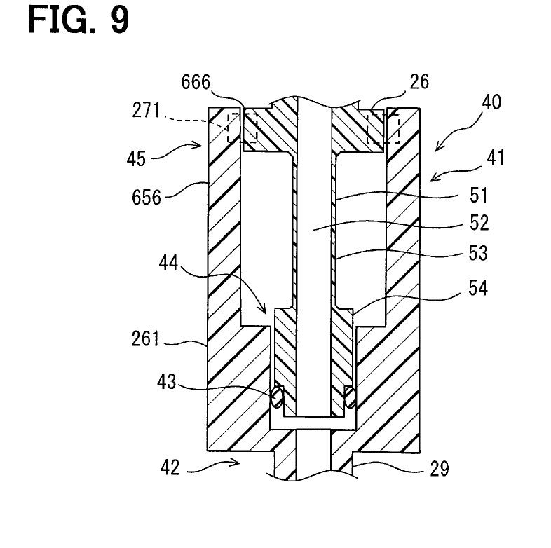

This embodiment is one of modifications based on a basic form provided by the preceding embodiment. In the preceding embodiments, the component engaging section 45 is provided by the engaging sections 56, 256, and 356 disposed in the first member 41 and the fitting section 66 disposed in the second member 42. Alternatively, in this embodiment, as shown in FIG. 9, the component engaging section 45 is provided by the engaging section 656 disposed on the second member 42 and the fitting section 666 disposed on the first member 41. The engaging section 656 extends along the axial direction from the second passage forming section 261. The fitting section 666 is disposed on a base portion of the first passage forming section 51. Also in this embodiment, the flexible pipe 53 is connected to the base portion of the fitting section 666 which provides the component engaging section 45. According to this embodiment, it is possible to achieve similar advantages in the preceding embodiments.

### Other Embodiments

The disclosure in this description is not restricted to the illustrated embodiment. The disclosure includes the illustrated embodiments and modifications by a person skilled in the art based on the illustrated embodiments. For example, disclosure is not limited to the component and/or the combination of the components shown in the embodiments. The disclosure can be carried out with various combinations. The disclosure may use additional parts which can be added to the embodiments. The disclosure may contain modifications in which component and/or element of the embodiments are removed. The disclosure may contain modifications in which component and/or element of the embodiments are exchanged or combined.

Technical scope of disclosure is not limited to the embodiments. It should be understood that some disclosed technical scope may be shown by description in the scope of claim, and contain all modifications which are equivalent to and within description of the scope of claim.

For example, in the preceding embodiments, the first member 41 is disposed on the first component 22, and the second member 42 is disposed on the second component 27. Alternatively, the second member 42 may be disposed on the first component 22, and the first member 41 may be disposed on the second component 27. Specifically, additionally or alternatively, a flexible pipe equivalent to the flexible pipe 53 may be disposed as a member belonging to the second component 27. In addition, additionally or alternatively, an engaging section equivalent to the engaging section 56 may be disposed as a member belonging to the second component 27. The insertion sections 54 and 55 may be disposed on one of the first member 41 and the second member 42, and the receiving sections 64 and 65 may be disposed on the other one of the first member 41 and the second member 42. The engaging sections 56, 256, and 356 may be disposed on one of the first member 41 and the second member 42, and the fitting section 66 may be disposed on the other one of the first member 41 and the second member 42.

In addition, the support mechanism 31 and the engaging mechanisms 35 and 71 illustrated in the above-mentioned embodiments may be replaced with various alternatives. For example, the support mechanism 31 may have an extension and contraction mechanism 32 like a swing-arm instead of a telescopic mechanism. In addition, the engaging mechanisms 35 and 71 may be provided by the various engaging mechanisms which may be used for a resin part. For example, the pawl and the hook in the engaging mechanisms 35 and 71 may be oppositely arranged. In addition, the engaging mechanisms 35 and 71 may be provided by a fastening mechanism using engagement with a male screw thread and a female screw thread, and/or a fastening mechanism using a bolt and a nut of separate components, instead of the snap-fit mechanism.

In the preceding embodiments, is possible for the flexible pipe 53 can be elastically deformed under anticipated use. Alternatively or additionally, the flexible pipe 53 may be formed plastically deformable.

What is claimed is:

1. A fuel supply device comprising:
a passage forming section (44) which defines and forms a fuel passage (52, 62) extending over a first member (41) and a second member (42) which are engaged by an engaging mechanism (71, 271);
a component engaging section (45) which engages the first member and the second member so that the first member and the second member are relatively positioned within a regular positional range;
a seal member (43) which seals between the first member and the second member, and which extends and contracts according to positional shifting of the first member and the second member within the regular positional range; and
a flexible pipe (53, 453, 553) which defines and forms a part of the fuel passage, and which is possible to be deformed according to positional shifting of the first member and the second member within the regular positional range by being arranged between the passage forming section and the component engaging section.

2. The fuel supply device claimed in claim 1, wherein
the passage forming section includes:
an insertion section (54, 55) which is disposed on one of the first member and the second member, and has a rigidity higher than the flexible pipe; and
a receiving section (64, 65) which is disposed on the other one of the first member and the second member, has a rigidity higher than the flexible pipe, and receives the insertion section.

3. The fuel supply device claimed in claim 2, wherein
the seal member is arranged between the insertion section and the receiving section.

4. The fuel supply device claimed in claim 3, wherein
the seal member is an O-ring which extends and contracts in the radial direction of the fuel passage according to positional movement of the first member and the second member within a regular positional range.

5. The fuel supply device claimed in any one of claims 1 to 4, wherein
the flexible pipe extends along an axis (AX) of the fuel passage.

6. The fuel supply device claimed in any one of claims 1 to 5, wherein
the flexible pipe is integrally formed with the passage forming section and/or the component engaging section with resin material.

7. The fuel supply device claimed in any one of claims 1 to 5, wherein
the flexible pipe is a component separate from the passage forming section and/or the component engaging section.

8. The fuel supply device claimed in any one of claims 1 to 7, wherein
the component engaging section has a rigidity higher than the flexible pipe.

9. The fuel supply device claimed in claim 8, wherein
the component engaging section has:
an engaging section (56, 256, 356, 656) which is disposed on one of the first member and the second member, and has a rigidity higher than the flexible pipe; and
a fitting section (66, 666) which is disposed on the other one of the first member and the second member, has a rigidity higher than the flexible pipe, and is fittingly coupled with the engaging section.

10. The fuel supply device claimed in claim 9, wherein
the engaging section includes:
an engaging leg (56a, 56b) extending along an axis (AX) of the fuel passage; and
an engaging ring (56c) which is disposed on a distal end of the engaging leg, and is fittingly coupled with the fitting section.

What is claimed is:

1. A fuel supply device comprising:
a passage forming section which defines and forms a fuel passage extending over a first member and a second member which are engaged by an engaging mechanism;
a component engaging section which engages the first member and the second member so that the first member and the second member are relatively positioned within a regular positional range;
a seal member which seals between the first member and the second member, and which extends and contracts according to positional shifting of the first member and the second member within the regular positional range; and
a flexible pipe which defines and forms a part of the fuel passage, and which is possible to be deformed according to positional shifting of the first member and the second member within the regular positional range by being arranged between the passage forming section and the component engaging section.

2. The fuel supply device claimed in claim 1, wherein
the passage forming section includes:
an insertion section which is disposed on one of the first member and the second member, and has a rigidity higher than the flexible pipe; and
a receiving section which is disposed on the other one of the first member and the second member, has a rigidity higher than the flexible pipe, and receives the insertion section.

3. The fuel supply device claimed in claim 2, wherein
the seal member is arranged between the insertion section and the receiving section.

4. The fuel supply device claimed in claim 3, wherein the seal member is an O-ring which extends and contracts in the radial direction of the fuel passage according to positional movement of the first member and the second member within a regular positional range.

5. The fuel supply device claimed claim 1, wherein
the flexible pipe extends along an axis of the fuel passage.

6. The fuel supply device claimed in claim 1, wherein
the flexible pipe is integrally formed with the passage forming section and/or the component engaging section with resin material.

7. The fuel supply device claimed in claim 1, wherein
the flexible pipe is a component separate from the passage forming section and/or the component engaging section.

8. The fuel supply device claimed in claim 1, wherein
the component engaging section has a rigidity higher than the flexible pipe.

9. The fuel supply device claimed in claim 8, wherein the component engaging section has:
an engaging section which is disposed on one of the first member and the second member, and has a rigidity higher than the flexible pipe; and
a fitting section which is disposed on the other one of the first member and the second member, has a rigidity higher than the flexible pipe, and is fittingly coupled with the engaging section.

10. The fuel supply device claimed in claim 9, wherein
the engaging section includes:
an engaging leg extending along an axis of the fuel passage; and
an engaging ring which is disposed on a distal end of the engaging leg, and is fittingly coupled with the fitting section.
